(19) United States
(12) Patent Application Publication
(10) Pub. No.: US 2014/0274539 A1
(43) Pub. Date: Sep. 18, 2014

(54) FULLY GEARED SINGLE INPUT ADAPTIVE CONTINUOUSLY VARIABLE TRANSMISSION

(71) Applicant: ERIC ORTON, Poulsbo, WA (US)

(72) Inventor: ERIC ORTON, Poulsbo, WA (US)

(21) Appl. No.: 13/834,522

(22) Filed: Mar. 15, 2013

(51) Int. Cl. F16H 3/78

(52) U.S. Cl. CPC F16H 3/78
USPC 475/205; 475/269

(57) ABSTRACT

An adaptive continuously variable transmission (CVT) constructed to automatically adjust gear ratio in response to changes in power to an input shaft, and to the load applied to the output shaft while still transmitting power to the output shaft. The transmission blends three compound planetary gear sets together so that the instantaneous difference in rotational speed between the input and output shafts sets the gear ratio and torque output of the transmission.

### TECHNICAL FIELD

The present invention relates to methods and systems for continuously variable transmissions. More particularly, the present invention relates to methods and systems relating to fully geared single input adaptive continuously variable transmissions.

### BACKGROUND

In general, in a transmission, speed change is done by selecting one of a number of predetermined gear ratios which creates inefficiencies. Conventional continuously variable transmissions use belts and cones, hydraulics, and ratchets which have a very complicated structures, are expensive to fabricate, and are limited due to their low load capacity and high wear potential.

The present invention addresses the drawbacks described above. The present invention for the first time provides an adaptable, fully geared, continuously variable transmission (CVT) which does not use complicated mechanisms, automatically responds to input or output load changes, transmits torque smoothly, and changes gear ratio steplessly. In the past, continuously variable transmissions that use compound planetary gear sets used two power inputs and/or elaborate split power controls systems to change gear ratio. In contrast, the present invention only has one power input and there are no control systems required. The transmission automatically adapts to changes in input power and/or changes in the power output requirements due to a novel integrated gearing configuration between three planetary gear sets.

### SUMMARY OF THE DISCLOSURE

The present invention provides an adaptive continuously variable transmission (CVT) constructed in such a way that it can automatically adjust gear ratio in response to changes in power to an input shaft, and to the load applied to the output shaft while still transmitting power to the output shaft. The transmission blends three compound planetary gear sets together so that the instantaneous difference in rotational speed between the input and output shafts sets the gear ratio and torque output of the transmission.

In one aspect, the transmission utilizes a one-way bearing clutch to prevent free-spinning of the internal gears of the transmission.

In another aspect, an adaptive continuously variable transmission utilizes three Planetary Gear Sets (PGS-1, PGS-2, and PGS-3), which have common Planet Carriers (PC), Ring Gears (RG), and Sun Gears (SG). The power inputted to PGS-1 (PC) transmits to the output shaft, which is PGS-2 (SG). A one-way clutch, which allows free-spin in one direction, is incorporated into PGS-2 (PC). Other benefits and advantages of the present invention will become apparent from the disclosure, claims and drawings herein.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows an example embodiment of a fully geared single input adaptive continuously variable transmission.

FIG. 2 schematically shows an example of an alternate embodiment of a fully geared single input adaptive continuously variable transmission.

FIG. 3 illustrates operational principles of an example of an embodiment of a fully geared single input adaptive continuously variable transmission.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several methods and systems for a fully geared single input adaptive continuously variable transmission. Several features of methods and systems in accordance with example embodiments are set forth and described in the Figures. It will be appreciated that methods and systems in accordance with other example embodiments can include additional procedures or features different than those shown in the Figures. Example embodiments are described herein. However, it will be understood that these examples are for the purpose of illustrating the principles, and that the invention is not so limited.

Additionally, methods and systems in accordance with several example embodiments may not include all of the features shown in these Figures. Throughout the Figures, identical reference numbers refer to similar or identical components or procedures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### DEFINITIONS

Generally, as used herein, the following terms have the following meanings when used within the context of continuously variable transmission apparatus and systems:

“CC” means the direction of clockwise rotation when viewed from the right side of the figures. Inversely, rotation in the opposite direction or counterclockwise is defined as “CCW”. Lack of rotation in either clockwise or counterclockwise is denoted as “NEG”.

“Operably linked” is understood as a connection, either physical, mechanical or electronic, between two components of the device, or a component of the device and a gear, linkage, remote sensor, data collector, controller, computer, or the like such that the components operate together as desired.

As used herein, “plurality” is understood to mean more than one. For example, a plurality refers to at least two, three, four, five, ten, 25, 50, 75, 100, or more.

Referring now to FIG. 1 an example embodiment of a fully geared single input adaptive continuously variable transmission is schematically shown. A continuously variable transmission comprises at least three compound planetary gear sets, PGS-1, PGS-2 and PGS-3 unified by a common combination gear 14. Combination gear 14 is operably connected to PGS-1, PGS-2 and PGS-3 and the combination gear 14 acts as a sun gear (SG/combination gear) for PGS-1, a ring gear (RG/combination gear) for PGS-2, and a planet carrier (PC/combination gear) for PGS-3. An input shaft 1 is operably connected to PGS-1 planet carrier (PC) 2 and PGS-3 ring gear (RG) 8.

A first planetary gear set PGS-1 is a differential that includes a first planet carrier (PC) 2 including a first ring gear (RG) 3 and a first sun gear (SG) 4. The first ring gear (RG) 3 meshes with a first idler gear 5. The first sun gear (SG) 4 meshes with a second idler gear 6, which meshes with a third idler gear 7. A first bearing 25 encompasses a portion of a first support arm 30 which is, in turn, connected to a stator at a first end. At a second end support arm 30 is connected to second idler gear 6. Support arm 30 has a second arm 31 connected to the third idler gear 7. In one useful example embodiment the first RG 3 and the first SG 4 comprise bevel gears having of the same size.

A second planetary gear set PGS-2 includes a first planet gear 11 coupled to a shaft 32 which runs through a second bearing 27, connected to a second planet carrier PC 10, and is rigidly connected to a second planet gear 12. A fourth idler gear 13 meshes to the second planet gear 12 and a second sun gear 15. The first planet gear 11 is meshed with the combination gear 14. First and second planet gears 11, 12 rotate together to provide a gear reduction since the first planet gear 11 is larger than the second planet gear 12. A one-way clutch 9 is attached to the planet carrier PGS-2 10. When engaged to ground PC 10, the one-way clutch 9 allows free-spin in one direction and prevents rotation in the opposite direction. In one example the clutch may advantageously comprise a one-way bearing clutch.

A third planetary gear set PGS-3 is a differential that includes a third ring gear (RG) 8 coupled to an output shaft 16. The output shaft 16 is also coupled to the second sun gear PGS-3 (SG) 15. The third ring gear PGS-3 (RG) 8 also meshes with the combination gear 14. In one useful example embodiment the second RG 8 is a bevel gear. These types of components are well known in the art such that a more elaborate description is not believed necessary for those skilled in the art.

Referring now to FIG. 2 an example embodiment of a fully geared single input adaptive continuously variable transmission is schematically shown. A continuously variable transmission comprises at least three compound planetary gear sets, PGS-1A, PGS-2 and PGS-3A unified by a common combination gear 14, which connects to all of the at least three compound planetary gear sets. The transmission is constructed substantially similar to the transmission of FIG. 1, but is different in the following respects. Planetary gear set PGS-1A includes planet carrier (PC) 2A including a first ring gear (RG) 3A and a first sun gear (SG) 4A which are aligned in parallel. A first bearing 25 encompasses a portion of a first support arm 30A which is, in turn, connected to a ground at a first end. At a second end support arm 30A is connected to second idler gear 6 and the third idler gear 7. In another departure from the transmission of FIG. 1, planetary gear set 3 PGS-3 includes a ring gear 8A. Operation is substantially as described below. In a departure from the configuration shown in FIG. 1, the third ring gear 8A which meshes with sun gear 15A is larger (i.e. has more gear teeth) than the sun gear 15A.

The continuously variable transmission can be used in any piece of equipment in which speed changes and output force varies. Fabrication of the CVT would be best accomplished through standard transmission assembly techniques since the CVT is fully geared, positive displacement, with no friction components. For this example motor vehicles will be used for describing the transmission operation. Also, for convenience, the direction of clockwise rotation when viewed from the right side of the figures, is taken as the direction of the input shaft “CC”. Inversely, rotation in the opposite direction or counterclockwise is defined as “CCW”. Lack of rotation in either clockwise or counterclockwise is denoted as “NEG”.

Referring again to FIG. 1, in operation, the input shaft 1 rotates when power is inputted from an engine (not shown). The input shaft 1 rotates PC 2 and RG 8 at the same time and at the same rotational velocity. Output shaft 16 rotates in the opposite direction from the input shaft 1. Depending upon the difference in the rotational velocity between the input shaft 1 and output shaft 16, the combination gear 14 will either spin clockwise (CC), counter clockwise (CCW), or NEG. The rotational velocity and direction of rotation of combination gear 14 will determine the power split at PGS-2, and determines whether more or less power goes to either the PC 10 or PGS-2 RG/combination gear 14. Assuming, for example that the CVT here is used in a vehicle with wheels, if more power is supplied than is required for a vehicle to maintain its current velocity, then there will be excess torque applied at the wheels causing the vehicle to accelerate. The rotational speed and direction of the combination gear will adjust with the acceleration allowing the vehicle to go faster, but while transmitting less torque as speed increase until equilibrium is reached between the input power and vehicle speed. PC 10 is connected to a one-way clutch 9 which only allows rotation in the CCW direction. Without the one way clutch 9 the internal gears of the transmission would free-spin and no torque would be transferred from the input shaft 1 to the output shaft 16.

Referring now to FIG. 3 operational principles of an example of an embodiment of a fully geared single input adaptive continuously variable transmission is illustrated.

### Example Calculation: Determining Gear Ratios

### W=Rotational Velocity of Gear or Shaft

W5=W1*(E/(1+E))+W6*(1/(1+E)) Equation 1

W4=W5*(1/(1+D))+W6*(D/(1+D)) Equation 2

W3=W1*(1+A)−W2*A Equation 3

W2=−W4*(1/B) Equation 4

W3=W5*(1/C) Equation 5

Combining Equations 3, 4, and 5 yields:

W5*(1/C)=W1*(1+A)+W4*(1/B)A

W5*(1/C)=W1*(1+A)+[W5*(1/(1+D))+W6*(D/(1+D))]*(A/B)

(Insert Equation 4 for W4)

W5*(1/C)=W1*(1+A)+W5*(A/(B+BD))+W6*(AD/(B+BD))

W5*(1/C)−W5*(A/(B+BD))=W1*(1+A)+W6*(AD/(B+BD))

W5*[(−AC+B+BD)/(BC+BCD)]=W1*(1+A)+W6*(AD/(B+BD))

W5=[W1*(1+A)+W6*(AD/(B+BD))]/[(−AC+B+BD)/(BC+BCD)]

W5=W1*(1+A)*[(BC+BCD)/(−AC+B+BD)]+W6*(AD/(B+BD))*[(BC+BCD)/(−AC+B+BD)]

W5=W1*(E/(1+E))+W6*(1/(1+E)) Equation 1

Therefore:

(1/(1+E))=(AD/(B+BD)))*[(BC+BCD)/(−AC+B+BD)] Equation 6

E*(1/(1+E))=(1+A)*[(BC+BCD)/(−AC+B+BD)] Equation 7

E*(AD/(B+BD))*=(1+A)*

E*(AD/(B+BD))=(1+A)

E=(1+A)*((B+BD)/AD)

For the example, planetary gear sets PGS-1 and PGS-3 are differentials and therefore their gear ratios are 1 and the following gear ratios for B, C, and D can be used for the example and the gear train will not bind. Should PGS-1 and PGS-3 not be differentials as in FIG. 2, then the gear ratios will be different than what is illustrated in this example to prevent binding. The table below illustrates some an example of useful gear ratios.

### Example

### Gear Ratio A: 1.00

### Gear Ratio B: 0.33

### Gear Ratio C: 0.20

### Gear Ratio D: 2.00

### Gear Ratio E: 1.00

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. An adaptive continuously variable transmission (CVT) comprising:
a first planetary gear set including a first planet carrier, a first ring gear and a first sun gear, where the first ring gear meshes with a first idler gear, the first sun gear meshes with a second idler gear, which meshes with a third idler gear, a first bearing encompasses a portion of a first support arm which is, in turn, connected to a stator at a first end and at a second end the first support arm is connected to the second idler gear, the first support arm includes a second arm component connected to the third idler gear;
a second planetary gear set includes a first planet gear coupled to a shaft which runs through a second bearing, connected to a second planet carrier, and is connected to a second planet gear, a fourth idler gear meshes to the second planet gear and a second sun gear, where first and second planet gears rotate together to provide a gear reduction, and a one-way clutch is operatively coupled to a second planet carrier; and
a third planetary gear set includes a third ring gear coupled to a output shaft where the output shaft is also coupled to the second sun gear, and the third ring gear also meshes with the combination gear.

2. The transmission of claim 1 wherein the first ring gear and the first sun gear comprise bevel gears of the same size.

3. The transmission of claim 1 wherein the first planetary gear set comprises a differential.

4. The transmission of claim 1 wherein one-way clutch comprises a one-way bearing clutch.

5. The transmission of claim 1 wherein the second ring gear comprises a bevel gear.

6. The transmission of claim 1 wherein the third planetary gear set comprises a differential.

7. The transmission of claim 1 wherein the combination gear is operably connected at different contact areas to each of the first planetary gear set, the second planetary gear set and the third planetary gear set such that the combination gear acts as a sun gear for the first planetary gear set, a ring gear for the second planetary gear set, and a planet carrier for the third planetary gear set.

8. The transmission of claim 1 wherein the first planetary gear set includes a first planet carrier including a first ring gear and a first sun gear aligned in parallel.

9. The transmission of claim 1 wherein the third ring gear which meshes with the second sun gear is larger than the sun gear.

10. The transmission of claim 1 wherein
the input shaft is adapted to rotate when power is applied for rotating a first planet carrier and a first ring gear at the same time and at the same rotational velocity;
the output shaft operates to rotate in the opposite direction from the input shaft; and
the combination gear spins clockwise (CC), counter clockwise (CCW), or NEG depending upon the difference in the rotational velocity between the input shaft and output shaft, where the rotational velocity and direction of rotation of combination gear determines a power split at the second planetary gear set, and determines whether more or less power goes to either the second planetary carrier or the RG/combination gear.

11. An adaptive continuously variable transmission (CVT) comprising:
means for automatically adjusting gear ratio in response to changes in power to an input shaft, and to the load applied to an output shaft while still transmitting power to the output shaft;
means for coupling and operating three compound planetary gear sets together so that the instantaneous difference in rotational speed between the input and output shafts sets a gear ratio and torque output of the transmission.

12. The transmission of claim 11 wherein the means for automatically adjusting gear ratio and the means for coupling and operating three compound planetary gear sets together are fully geared.

13. The transmission of claim 11 comprising a one-way bearing clutch operably coupled to the coupling means.

14. The transmission of claim 11 wherein the three compound planetary gear sets include planet carriers, ring gears, and sun gears.

15. The transmission of claim 1 wherein
the input shaft is adapted to rotate when power is applied for rotating a first planet carrier and a first ring gear at the same time and at the same rotational velocity;
the output shaft operates to rotate in the opposite direction from the input shaft; and
the means for coupling and operating three compound planetary gear sets comprises a combination gear.

16. The transmission of claim 15 wherein the combination gear spins clockwise (CC), counter clockwise (CCW), or NEG depending upon the difference in the rotational velocity between the input shaft and output shaft.

17. The transmission of claim 16 wherein the rotational velocity and direction of rotation of combination gear determines a power split at a second planetary gear set, and determines whether more or less power goes to either the second planetary carrier or the RG/combination gear.
